(19) United States
(12) Patent Application Publication
(10) Pub. No.: US 2002/0079702 A1
(43) Pub. Date: Jun. 27, 2002

(54) Flexible conduit element with a connection device attached to at least one end

(75) Inventors: Roland Baumann, Ulm (DE); Peter Schuttler, Niefern-Oschelbronn (DE); Franz Dorge, Keltern -3-Weiler (DE); Bernd Michelfelder, Karlsruhe (DE); Bernd Seeger, Pforzheim (DE); Manfred Mader, Schwadorf (AU)

Correspondence Address: VOLPE AND KOENIG, P.C., SUITE 400, ONE PENN CENTER, 1617 JOHN F. KENNEDY BOULEVARD, PHILADELPHIA, PA, 19103, US

(73) Assignee: Witzenmann GmbH Metallschlauch-Fabrik Pforzheim, Pforzheim (DE)

(21) Appl. No.: 09/765,100

(22) Filed: Jan. 18, 2001

(30) Foreign Application Priority Data
Jan. 19, 2000 (EP) 200 00 888.9
Mar. 8, 2000 (EP) 200 04 316.1
Sep. 26, 2000 (EP) 00 120 910.5

(51) Int. Cl. F16L 17/025

(52) U.S. Cl. 285/343; 285/354; 285/903; 138/109; 138/121

(57) ABSTRACT

A flexible conduit element that is made out of an annular corrugated tube or an annular corrugated pipe and is provided with a connection device. The connection device 6 is located on one end of the flexible conduit element and includes a joining piece 2 that has an external threading 5 and is placed on the end of the flexible conduit element 1. A union nut 3 can be shoved onto the flexible conduit element 1 and screwed onto the outer threading 5 of the joining piece 2, and a clamping ring 4 that can be shoved onto the flexible conduit element 1, is arranged between and deformed by the joining piece 2 and the union nut 3.

Translation of U.S. application Ser. No. 09/765,100

### BACKGROUND

The invention involves a flexible conduit element with a connection device attached to at least one end, whereby the flexible conduit element is made out of an annular corrugated tube or an annular corrugated pipe.

Annular corrugated tubes and/or annular corrugated pipes are made out of a lined-up arrangement of annular closed, parallel individual corrugations and offer in this way the possibility for elastically bending the conduit element made out of them until reaching a minimum radius. Since they can thus be gas and/or liquid impermeable, they are excellently suited for the flexible laying of liquid lines or for the offset of vibrations and heat expansions. It is problematic, however, that the connection of these conduit elements must as a rule be done in a gas and/or liquid-impermeable manner. Because of the corrugated wall, special connection techniques are necessary.

Traditional connection techniques, which connected a fitting to an annular corrugated tube or an annular corrugated pipe in a liquid impermeable manner, require special expertise and special tools during assembly: Thus, for example, there are welding fittings, in which a sheath is placed over the end of the corrugated tube or corrugated pipe that is to be connected, and is welded to it all the way around. As an alternative to this, there are also soldered fittings, which are connected by soldering to the corrugated pipe or the corrugated tube. A third joining technique deforms the tube end and/or the pipe end in such a way that the last two to three corrugations are shoved together axially and in this way they form a flange, onto which a specially constructed fitting can then be flange-mounted by screwing it tight.

The traditional connection techniques for the annular corrugated pipes and/or annular corrugated tubes thus require tools and expertise on site, and as a result, the use of these flexible conduit elements is limited to specialized personnel. However, a simple connection technique would be desirable that could also be handled by a do-it-yourself worker.

The object of the invention is thus to make available a flexible conduit element with a connection device of the type noted at the beginning, which allows a simple, fast, and thus proper connection on site.

This object is achieved by a flexible connection element and an associated connection device with the characteristics of the attached patent claims 1 and 8.

Advantageous embodiments of the invention are found in the respective subsequent patent claims.

The connection device, which is mounted onto at least one end of the flexible conduit element constructed as an annular corrugated tube or annular corrugated pipe, encloses, according to the invention, a joining piece that has an external threading and is placed on the end of the flexible conduit element and surrounds it, a union nut that can be shoved onto the flexible conduit element and screwed onto the outer threading of the joining piece, as well as a clamping ring that can be shoved onto the flexible conduit element, arranged between the joining piece and the union nut and deformed by them.

A clamping ring of this type and the parts deforming them are themselves known from the prior-art of traditional clamping ring screwed connections in cylindrical pipes. According to the invention, however, it has been recognized in a surprising way that a liquid-impermeable clamping ring connection is possible with corresponding dimensioning of the parts involved even for annular corrugated pipes and annular corrugated hoses. In this way, as large a flexibility as possible results in the assembly of these flexible conduit elements: The conduit elements can be shortened to any desired length on site; a fitting can then be made using the connection device according to the invention with the simplest tools, namely a wrench or a corresponding pair of pliers. The union nut and the clamping ring merely need to be shoved onto the corrugated pipe or the corrugated hose and the joining piece plugged in, so that in this way by screwing the union nut onto the joining piece, the clamping seat of the fitting is made. A deformation of the pipe end and/or the tube end or a connection of the fitting using welding or soldering can thus be completely omitted.

Depending on the material of the corrugated pipe or corrugated tube—preferably a metal is used for it, in particular a non-rusting, austenitic stainless steel -, different materials can be used for the clamping ring, such as, for example, brass, stainless steel or plastic. The profile of the clamping ring can, as is usual in the joining technology for cylindrical pipes, be constructed so that it is bent in a convex manner; however, it can also be advantageous to provide the clamping ring with a trapezoidal profile so that more deformation material results, which partially flows into the corrugation valleys during the deformation. For this same reason, it can be sensible depending on the dimensioning of the connection device, to provide an essentially rectangular or essentially round profile for the clamping ring.

In all of these cases, it is advantageous if the joining piece and the union nut of the connection device according to the invention each have a cone that comes into contact with the clamping ring in order to deform it, and as a result, deforms it radially to the inside to produce the clamp.

Since the clamping ring will generally deform in such a way that its edges move to the axis of the pipe faster than the rest of the material, it will usually be functional if the clamping ring is constructed so wide that it covers at least two corrugation peaks. Otherwise, there could be the danger that the clamping ring will bend around a single corrugation peak and a liquid impermeability of the connection would thus no longer be ensured.

In the same regard, it is advantageous if the clamping ring is shoved onto the flexible conduit element in such a way that its edges are arranged respectively between two corrugation peaks. If the clamping ring is furthermore constructed so that its edges deform inwards into the corrugation valleys when the union nut is screwed onto the joining piece, on the one hand, the safeguarding against an axial pull-out is improved, and on the other hand, the edges of the clamping ring can come to be tightly fitted along the corrugation radius into the corrugation flank on the corrugation peak and thus ensure a reliable, surrounding seal. In addition, a defined deformation of the clamping ring does not even need to be made, since it is not important at which position of the bending radius of the corrugation peak the clamping and thus the seal will be made.

Special advantages are provided, if the clamping ring that is used has edges that are flattened out and/or provided with a targeted bending point, in particular a constriction. The deformation of the edges into the corrugation valleys and the tightly fitting onto the respective corrugation flanks is forced by this. The constrictions can in this way be provided on the side of the clamping ring that lies radially outwardly; however, it is also possible instead of or in addition to these constrictions, to provide additional constrictions or notches on the side of the clamping ring that lies radially inwardly. These constrictions or notches lying on the inside can be adapted to the outer profile of the corrugated pipe or corrugated tube in such a way that they make possible an exact alignment of the clamping ring during the assembly—for example, in order to cover exactly two corrugations—and ensure an automatic adjustment of its axial position at the latest during the deformation.

Additional advantages can be obtained if the clamping ring that is used has, on the side of its profile that lies radially to the inside, a recess or a notch that is arranged approximately in the middle: This supports its deformability in the axial direction and guides the deformation into the corrugation valleys. A clamping ring that is constructed in this way can furthermore be arranged on the corrugated pipe or corrugated tube in such a way that it covers only one corrugation peak axially. This corrugation peak is then pressed into the preferably correspondingly adapted recess on the inside of the clamping ring during the deformation, while its material comes to fit tightly on the corrugation flanks.

It is apparent that the use of clamping rings with targeted bending points or recesses lying on the inside make it possible to make a liquid impermeable connection even when the clamping ring only covers a single corrugation peak axially.

A few preferred embodiments of the invention are described and explained in greater detail using the attached drawings. Shown are:

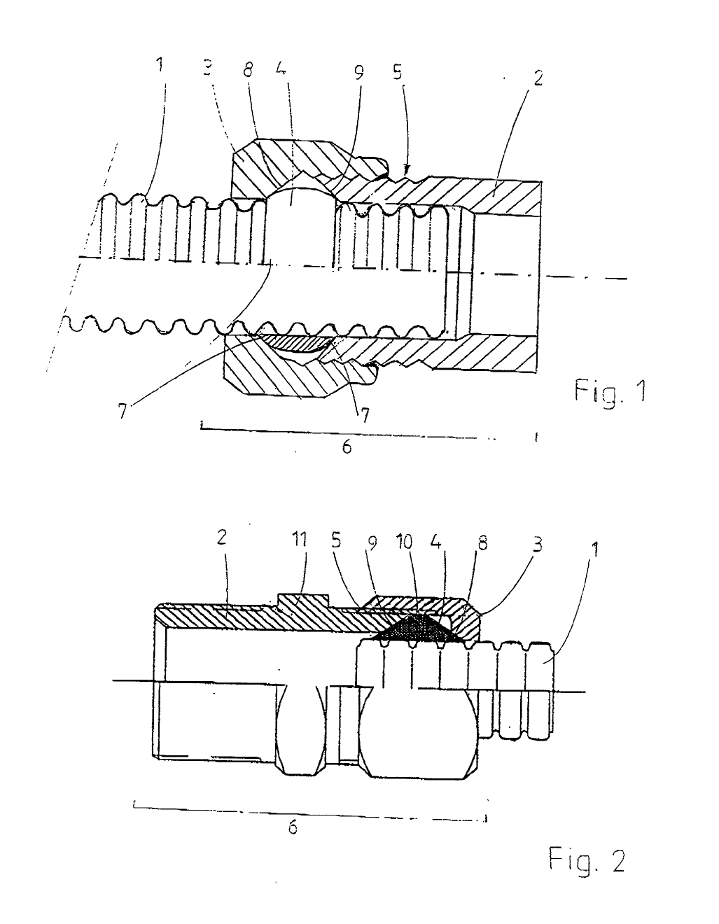

FIG. 1 is a section through a conduit element according to the invention with a connection device;

FIG. 2 is a partial section view of another embodiment form of a conduit element with a connection device according to the invention;

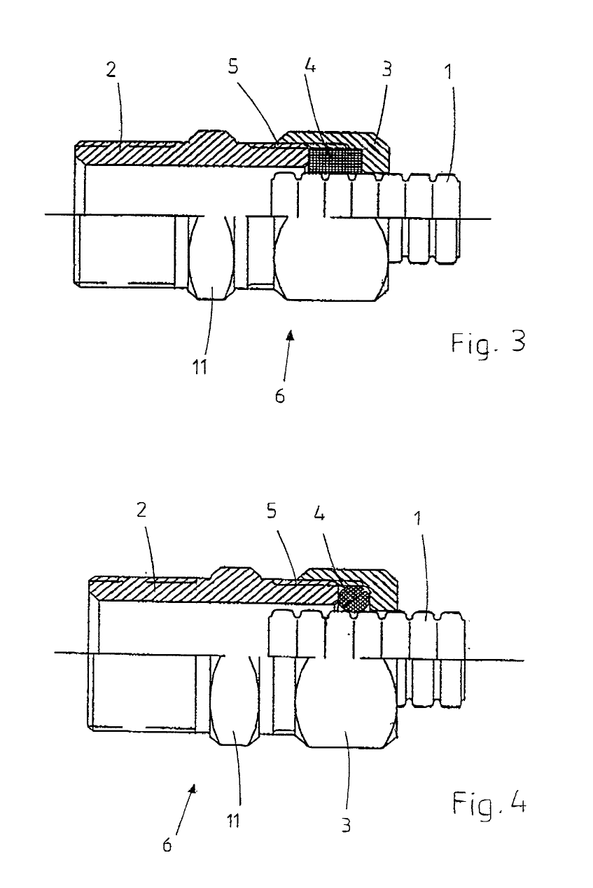

FIG. 3 is a view according to FIG. 2 of another embodiment form;

FIG. 4 is a view according to FIG. 2 of another embodiment form;

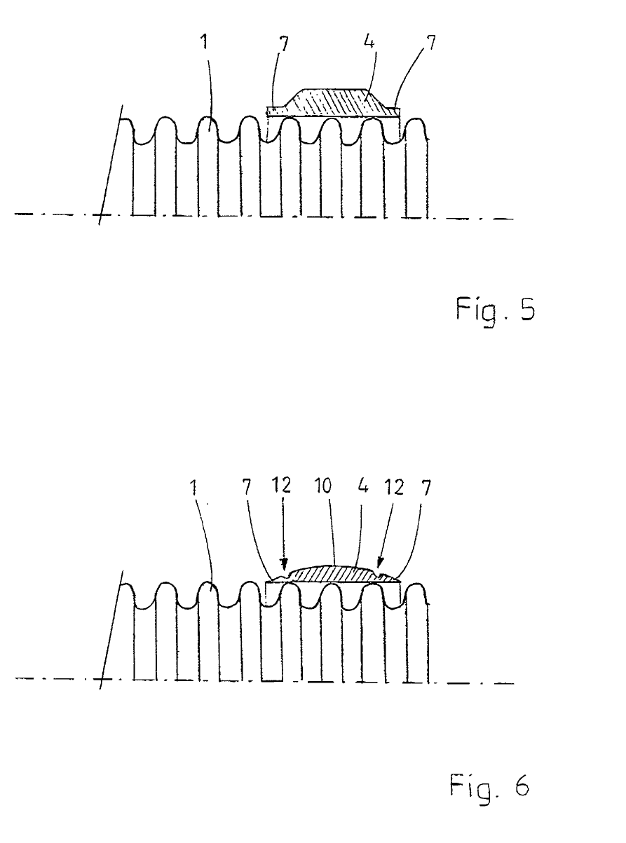

FIG. 5 is a schematic sectional diagram of a conduit element with the clamping ring shoved on;

FIG. 6 is a view like FIG. 5, but of another embodiment form;

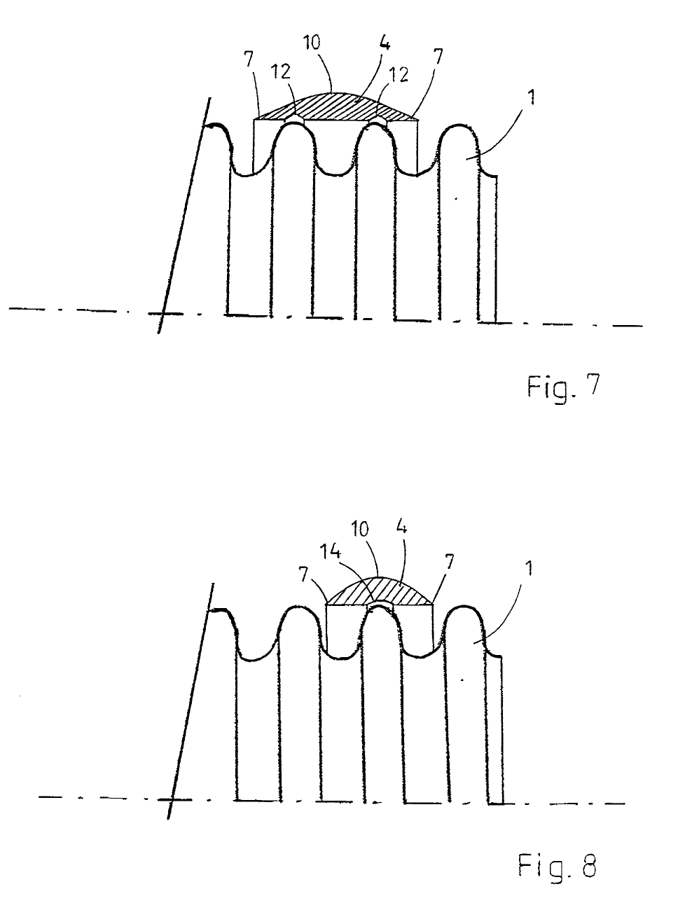

FIG. 7 is a view like FIG. 5, but of another embodiment form;

FIG. 8 is a view like FIG. 5 with another embodiment form;

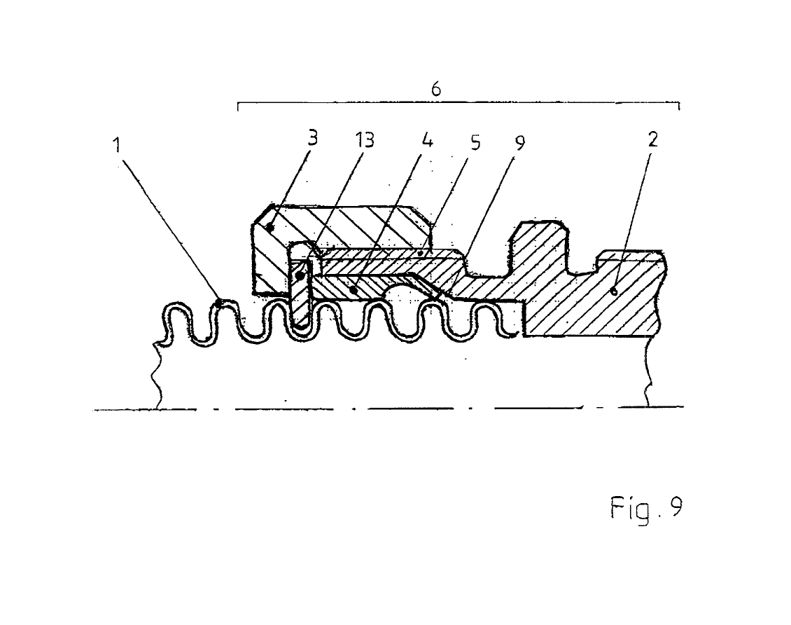

FIG. 9 is a schematic sectional diagram of another embodiment form of a conduit element according to the invention with a connection device.

In FIG. 1, a flexible conduit element 1, which is constructed here as an annular corrugated metal tube, is plugged into a joining piece 2. Prior to plugging in the flexible conduit element 1 into the joining piece 2, a union nut 3 and a clamping ring 4 were shoved onto the corrugated tube. The clamping ring 4 thus lies between the union nut 3 and the joining piece 2. The joining piece 2 is provided on the tube side with an external threading 5, onto which the union nut 3 can be screwed.

FIG. 1 shows an arrangement, ready for mounting, of the connection device 6 including the joining piece 2, the union nut 3, and the clamping ring 4. The clamping ring 4 lies with its edges 7 on one side, on a cone 8 of the union nut 3 and on the other side, on a cone 9 of the joining piece 2. If the union nut 3 is then further screwed onto the outer threading 5 of the joining piece 2, the clamping ring 4 is deformed starting from its edges 7 and in this way pressed radially onto the corrugated tube, whereby both an axial pull-out safeguard as well as a liquid-impermeable sealing of the connection device 6 is produced. The joining piece 2, which is only shown shortened here, can be provided on its connection-side end with a flange, an additional threading, or a mirror-image connection device for attaching two flexible conduit elements.

FIG. 2 shows a similar partial sectional representation as FIG. 1, but of another embodiment. The flexible conduit element 1 is in turn an annular corrugated metal tube, whereby the connection piece 2 is constructed here as a pipe connection. The main difference from the embodiment shown in FIG. 1 is in the profiling of the clamping ring 4, which shows a trapezoidal profile here. The cone 8 of the union nut 3 and the cone 9 of the joining piece 2 are constructed corresponding to the splayed on edge areas of the clamping ring 4, such that an additional peculiarity results in that the back 10 of the clamping ring 4 extends to the inner wall of the union nut 3.

Finally, through the partial section diagram of FIG. 2, it is made clear that two wrenches or water pump pliers or the like, which are set on the union nut 3 and on a hexagon 11 on the joining piece 2, are fully sufficient for the mounting of the connection device 6 according to the invention. Special tools or any other special expertise are not necessary.

FIG. 3 shows a view as in FIG. 2, whereby here a clamping ring 4 with a completely different profile, namely, a rectangular profile, is used. Correspondingly, the union nut 3 and the joining piece 2 are not provided with a cone. Besides this, reference may be made to the description of FIG. 2.

FIG. 4 shows an almost identical embodiment as FIG. 3, except here a clamping ring 4 with a round cross-section, i.e. in the manner of an O-ring seal, is provided. As can be recognized well here, only one corrugated valley is covered by the clamping ring 4, into which the material of the clamping ring 4 can flow during the deformation by screwing on the union nut 3.

FIGS. 5 and 6 each show in schematic diagrams additional embodiments for advantageous profiling of the clamping ring 4 that is present in the connection device 6: Whereas FIG. 5 shows a clamping ring 4 with flattened, stretched out edges 7, the back 10 of the clamping ring 4 in FIG. 6 is provided with a convex profile and the edges 7 are each provided with a constriction 12, which forms a generally targeted bending point. In both cases, the clamping ring 4 is functionally used with a joining piece 2 and a union nut 3, both of which are provided with a cone 8 and/or 9.

As shown in FIGS. 5 and 6, the edges 7 of the clamping ring 4 for the mounting each come to lie over one corrugated valley of the flexible conduit element 1, so that they are deformed during deformation into these corrugated valleys and lie sealing on the respective corrugated flanks. At which point of their outer radius the sealing support is finally made is not important. Furthermore, it is immediately clear that this type of deformation of the edges 7 of the clamping ring 4 offers an excellent axial pull-out safeguard.

In FIG. 7, an additional embodiment form of a clamping ring 4 is shown in a representation corresponding to FIGS. 5 and 6: Here, the constrictions 12 on the edges 7 of the clamping ring 4 are not made as in the previous embodiment example on the back 10 of the clamping ring 4, but instead on the radially inner-lying side of the clamping ring profile. As is clear using this representation, the side effect results from this that the corrugation peaks lying immediately below the constrictions 12 are pressed into these constrictions 12 during the deformation of the clamping ring 4, such that an automatic, exact axial orientation of the clamping ring 4 results on the flexible conduit element 1. Provided the assembly of the connection device according to the invention is done for a more or less horizontally running flexible conduit element 1, the clamping ring 4 can rest because of gravity on the upper side of the corrugated tube after it is shoved onto the corrugated tube so that the constrictions 12, which are preferably fitted to the corrugated shape, readily lie on two adjacent corrugation peaks and receive them so that an axial orientation of the clamping ring 4 occurs automatically.

The embodiment shown in FIG. 8, of a clamping ring 4 that is present in the connection device has on the radially internal side of its profile an approximately centered notch 14, whereas its back 10 is bent in a conventionally convex manner. The notch 14 is as shown preferably adapted to the form of the corrugation peaks of the flexible conduit element 1 and can receive a corrugation peak during the deformation of the clamping ring 4, so that on the one hand, an axial orientation of the clamping ring 4 results, and on the other hand, the axial covering of a single corrugation peak is sufficient in order to ensure a liquid-impermeable connection.

Finally, FIG. 9 shows a clearly different embodiment than the previous Figures, in turn in a schematic sectional diagram: Shown are a flexible conduit element 1, which is constructed as a metallic annular corrugated tube, together with a connection device 6, whereby the connection device 6 encloses a joining piece 2 with a cone 9 and an external threading 5, a union nut 3 and a clamping ring 4. In addition, a mounting ring 13 is now provided, which is constructed so that it is divided and/or can be closed and in this way can be set so that it is form-fit in a corrugation valley of the flexible conduit element 1. In this way, a defined orientation of the clamping ring 4 automatically results, which intentionally contacts only the outer rims of the individual corrugations, in order to create a clamping seal there. The pull-out safeguard is essentially ensured by the mounting ring 13, which is affixed using the union nut 3 onto the joining piece 2. Furthermore, the mounting ring 13 offers here a defined stopper on the joining piece 2, so that the union nut 3 can not be screwed onto the outer threading 5 of the connection piece 2 further than is necessary for the defined deformation of the clamping ring 4. Of course, for all other embodiments of a clamping ring 4 mentioned above, a mounting ring 13 can be additionally provided.

Reference list

| | |
|---|---|
| 1 | flexible conduit element |
| 2 | joining piece |
| 3 | union nut |
| 4 | clamping ring |
| 5 | outer threading |
| 6 | connection device |
| 7 | edges (of 4) |
| 8 | cone (of 3) |
| 9 | cone (of 2) |
| 10 | back (of 4) |
| 11 | hexagon |
| 12 | constriction |
| 13 | mounting ring |
| 14 | notch |

* * *

What is claimed is:

1. Flexible conduit element with a connection device attached to at least one end, whereby the flexible conduit element is made out of an annular corrugated tube or an annular corrugated pipe, characterized in that, the connection device (6) comprises a joining piece (2) that has an external threading (5) and is placed on the end of and surrounds the flexible conduit element (1), a union nut (3) that can be shoved onto the flexible conduit element (1) and screwed onto the outer threading (5) of the joining piece (2), and a clamping ring (4) that can be shoved onto the flexible conduit element (1), arranged between and deformed by the joining piece (2) and the union nut (3).

2. Flexible conduit element according to claim 1, characterized in that, the clamping ring (4) of the connection device (6) is constructed to have a width sufficient to cover at least two corrugation peaks of the flexible conduit piece (1).

3. Flexible conduit element according to one of the claims 1 or 2, characterized in that, the clamping ring (4) of the connection device (6) is shoved onto the flexible conduit element (1) in such a way that its edges (7) are arranged respectively between two corrugation peaks of the conduit element (1).

4. Flexible conduit element according to claim 3, characterized in that, the clamping ring (4) of the connection device (6) has edges (7) that are flattened out and/or provided with a targeted bending point (12).

5. Flexible conduit element according to one of the claims 3 or 4, characterized in that, the clamping ring (4) of the connection device (6) is constructed so that its edges (7) deform inwardly into the corrugation valleys of the conduit element (1) when the union nut (3) is screwed onto the joining piece (2).

6. Flexible conduit element according to one of the claims 1 to 5, characterized in that, the joining piece (2) and the union nut (3) of the connection device (6) each have a cone (8, 9) for contact with the clamping ring (4) in order to deform it.

7. Flexible conduit element according to one of the claims 1 to 5, characterized in that, the connection device (6) encloses a mounting ring (13) that grasps into a corrugation valley of the flexible conduit element (1) and is arranged axially next to the clamping ring (4).

8. Connection device for a flexible conduit element according to one of the claims 1 or 7, comprising a joining piece (2) that has an external threading (5) and is set onto and surrounds an end of the flexible conduit element (1), a union nut (3) that can be shoved onto the flexible conduit element (1) and screwed onto the outer threading (5) of the joining piece (2), and a clamping ring (4) that can be shoved onto the flexible conduit element (1), arranged between and to be deformed by the joining piece (2) and the union nut (3).

9. Connection device according to claim 8, characterized in that, the clamping ring (5) has a trapezoidally shaped or convex bent profile.

10. Connection device according to claim 8, characterized in that, the clamping ring (4) has an essentially rectangular or an essentially round profile.

11. Connection device according to one of the claims 8 to 10, characterized in that, the clamping ring (4) has a profile with edges (7) that are flattened out and/or provided with constrictions (12).

12. Connection device according to one of the claims 8 to 11, characterized in that, the clamping ring (4) has on the radially inner side of its profile an approximately centered recess or notch (14).

13. Connection device according to one of the claims 8 to 12, characterized in that, axially next to the clamping ring (4), an additional mounting ring (13) is provided that grasps into a corrugation valley of the flexible conduit element (1).
